(19) United States
(12) Patent Application Publication
(10) Pub. No.: US 2007/0076681 A1
(43) Pub. Date: Apr. 5, 2007

(54) Method and apparatus for dynamically allocating internet protocol address inwireless network

(75) Inventors: Jin-woo Hong, Suwon-si (KR); Dae-gyu Bae, Suwon-si (KR); Hyun-ah Sung, Seoul (KR); Se-Hoon Moon, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/515,828

(22) Filed: Sep. 6, 2006

(30) Foreign Application Priority Data
Sep. 10, 2005 (KR) 10-2005-0084433

(51) Int. Cl. H04J 3/24

(52) U.S. Cl. 370/349; 370/389

(57) ABSTRACT

A method and apparatus for dynamically allocating an Internet Protocol (IP) address in a wireless network associates a wireless network device in a specified wireless network and sets an IP address by using an association value of a network ID of the wireless network and a logical address used to identify a wireless network device in the wireless network.

### CROSS-REFERENCE TO RELATED APPLICATION

This application claims priority from Korean Patent Application No. 10-2005-0084433, filed on Sep. 10, 2005, the disclosure of which is incorporated herein in its entirety by reference.

### BACKGROUND OF THE INVENTION

1. Field of the Invention

The present invention relates to the allocation of an Internet Protocol (IP) address, and more particularly, to a method and apparatus for dynamically allocating an IP address in a wireless network.

2. Description of the Prior Art

With the development of communication and network technologies, a network environment has recently been changed from a wired network environment using a coaxial cable or an optical cable to a wireless network environment using wireless signals of diverse frequency bands. Accordingly, computing devices which include wireless network interface modules and perform specified functions by processing diverse kinds of information (hereinafter referred to as “wireless network devices”) have been developed. In addition, technologies related to a wireless network, which enable wireless network devices to perform efficient communications, have been proposed.

Such a wireless network may be divided into two types. One is a wireless network that includes an access point, and is called an infrastructure mode wireless network. The infrastructure mode wireless network requires an access point that relays communications between the wireless network devices constituting the wireless network, or communications between the wireless network and a wired network. Since the access point serves to relay the data transfer, all data being transmitted from the wireless network of the infrastructure should pass through the access point.

The second type of wireless network is a wireless network that includes no access point, and is called an ad-hoc mode wireless network. The ad-hoc mode wireless network enables wireless network devices that belong to a common wireless network to directly transmit data to each other without any relay device.

In order to perform IP communications in a wireless network, respective wireless network devices should be allocated with IP addresses. If the IP addresses are to be dynamically allocated, a dynamic host configuration protocol (DHCP) server is required. In the infrastructure mode wireless network, the access point can be connected to the DHCP server through a wired network, and thus the wireless network devices can be easily allocated with the IP addresses from the DHCP server through the access point. However, since in general, the wireless network device that constitutes the ad-hoc mode wireless network is a mobile device, it is not easy for a specified wireless network device to serve as the DHCP server in the ad-hoc mode.

Accordingly, a technology that can make it possible to dynamically allocate an IP address more easily in an ad-hoc mode wireless network is required.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

Aspects of the invention will be set forth in part in the description which follows and in part will become apparent to those having ordinary skill in the art upon examination of the following or may be learned from practice of the invention.

According to an aspect of the present invention, there is provided a method of dynamically allocating an IP address in a wireless network, which may include associating a wireless network device in a specified wireless network, and setting an IP address by using an association value of a network ID of the wireless network and a logical address that is used to identify the wireless network device in the wireless network.

In another aspect of the present invention, there is provided a method of dynamically allocating an IP address in a wireless network, which may include requesting an IP address to a coordinator of a coordinator based wireless network, receiving from the coordinator as a result of the request a response frame that includes the IP address generated using an association value of a network ID that is used in the coordinator based wireless network and an IP address allocation order that is generated in accordance with the coordinator's allocation of the IP address, and setting the IP address included in the response frame.

In still another aspect of the present invention, there is provided a method of dynamically allocating an IP address in a wireless network, which may include receiving an IP address allocation request from a wireless network device in a coordinator based wireless network, generating an IP address using an association value of a network ID that is used in the coordinator based wireless network and a logical address of the wireless network device, and transmitting a response frame that includes the generated IP address to the wireless network device.

In still another aspect of the present invention, there is provided a method of dynamically allocating an IP address in a wireless network, which may include receiving an IP address allocation request from a wireless network device in a coordinator based wireless network, generating an IP address using an association value of a network ID that is used in the coordinator based wireless network and an IP address allocation order that is generated in accordance with the allocation of the IP address, and transmitting a response frame that includes the generated IP address to the wireless network device.

In still another aspect of the present invention, there is provided a method of dynamically allocating an IP address in a wireless network, which may include generating a network ID to be used in a specified wireless network, generating a beacon frame that includes the network ID, and broadcasting the beacon frame, wherein a wireless network device having received the beacon frame generates an IP address by connecting the network ID with a logical address of the wireless network device.

In still another aspect of the present invention, there is provided a wireless network device, which may include a communication module receiving a beacon frame that includes a network ID in a specified wireless network, an IP information management module generating an IP address using an association value of the network ID included in the beacon frame and a logical address that is used to identify a wireless network device in the wireless network, and a control module setting the generated IP address.

In still another aspect of the present invention, there is provided a wireless network device, which may include a request module generating a request frame for requesting an IP address to a coordinator of a coordinator based wireless network, a communication module transmitting the request frame to the coordinator and receiving from the coordinator a response frame that includes the IP address generated using an association value that the coordinator has generated from a network ID of the coordinator based wireless network and a logical address being used to identify a wireless network device in the coordinator based wireless network, and a control module setting the IP address included in the response frame.

In still another aspect of the present invention, there is provided a wireless network device, which may include an IP information management module generating an IP address using an association value of a network ID that is used in a coordinator based wireless network and a logical address of a wireless network device having requested an allocation of the IP address, a response module generating a response frame that includes the IP address, and a communication module receiving the IP address allocation request from a wireless network device and transmitting the response frame to the wireless network device.

In still another aspect of the present invention, there is provided a wireless network device, which may include an IP information management module generating a network ID to be used in a specified wireless network, a beacon frame generation module generating a beacon frame that includes the network ID, and a communication module broadcasting the beacon frame, wherein a wireless network device having received the beacon frame generates an IP address by connecting the network ID with a logical address of the wireless network device.

### BRIEF DESCRIPTION OF THE DRAWINGS

The above and other aspects of the present invention will be more apparent from the following detailed description taken in conjunction with the accompanying drawings, in which:

FIG. 1 is a block diagram illustrating a coordinator based wireless network according to an exemplary embodiment of the present invention;

FIG. 2 is a diagram illustrating a temporal arrangement structure for communications between wireless network devices in a coordinator based wireless network according to an exemplary embodiment of the present invention;

FIG. 3 is a view illustrating the structure of an IP request frame according to an exemplary embodiment of the present invention;

FIG. 4 is a diagram illustrating the structure of an IP response frame according to an exemplary embodiment of the present invention;

FIG. 5 is a diagram illustrating the structure of a beacon frame according to an exemplary embodiment of the present invention;

FIG. 6 is a block diagram illustrating the construction of a wireless network device according to an exemplary embodiment of the present invention;

FIG. 7 is a block diagram illustrating the construction of a wireless network device according to another exemplary embodiment of the present invention;

FIG. 8 is a flowchart illustrating an IP address allocation method according to an exemplary embodiment of the present invention;

FIG. 9 is a flowchart illustrating an IP address allocation method according to another exemplary embodiment of the present invention;

FIG. 10 is a diagram illustrating a distributed wireless network according to an exemplary embodiment of the present invention;

FIG. 11 is a diagram illustrating a temporal arrangement structure for communications between wireless network devices in a distributed wireless network according to an exemplary embodiment of the present invention;

FIG. 12 is a diagram illustrating the structure of a beacon frame according to an exemplary embodiment of the present invention;

FIG. 13 is a block diagram illustrating the construction of a wireless network device according to an exemplary embodiment of the present invention; and

FIG. 14 is a flowchart illustrating an IP address allocation method according to another exemplary embodiment of the present invention.

### DETAILED DESCRIPTION OF THE EXEMPLARY EMBODIMENTS

Hereinafter, exemplary embodiments of the present invention will be described in detail with reference to the accompanying drawings. The aspects and features of the present invention and methods for achieving the aspects and features will be apparent by referring to the exemplary embodiments to be described in detail with reference to the accompanying drawings. However, the present invention is not limited to the exemplary embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the exemplary embodiments of the present invention, the same drawing reference numerals are used for the same elements across various figures.

In the exemplary embodiments of the present invention, a wireless network device is a computing device that performs a wireless communication function, and has diverse types of data processing capabilities. Examples of such a wireless network device include a notebook computer, a PDA, and a mobile phone.

In the exemplary embodiments of the present invention, a wireless network means a ad-hoc mode wireless network in which wireless network devices that constitute a single network without any relay device such as an access point can directly transmit data to each other.

This ad-hoc mode wireless network may be divided into two types. One is a wireless network in which one wireless network device selected among wireless network devices belonging to the same wireless network serves as a coordinator that allocates times for transmitting data to other wireless network devices (hereinafter referred to as “channel times”), and other wireless network devices occupy communication channels and transmit data at the channel times allocated to them. Hereinafter, this type of ad-hoc wireless network will be called a “coordinator based wireless network.” A wireless personal area network of the IEEE 802.15.3 standard may be a representative example of the coordinator based wireless network.

The second type wireless network is a wireless network in which no wireless network device that serves as a coordinator exists, and all wireless network devices can transmit data at their desired times through mutual tuning. Hereinafter, this type of ad-hoc wireless network will be called a “distributed wireless network.” A multiband orthogonal frequency division modulation (OFDM) alliance medium access control (MBOA MAC) network, of which the standardization has been performed by Samsung Electronics Co., Ltd., Intel Corp., Nokia, and others, may be a representative example of the distributed wireless network.

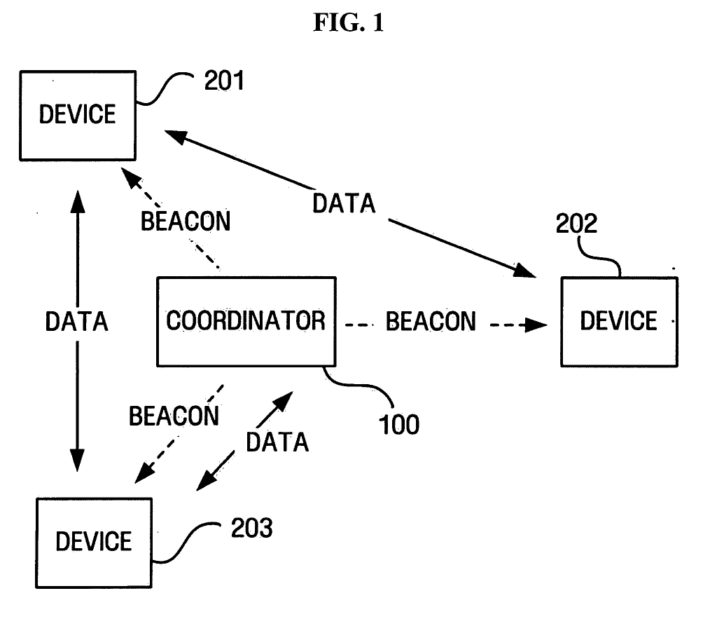

Hereinafter, the coordinator based wireless network and the distributed wireless network, to which exemplary embodiments of the present invention are applied, will be explained in more detail. First, the coordinator based wireless network to which the present invention is applied will be explained with reference to FIGS. 1 to 9.

FIG. 1 is a diagram illustrating a coordinator based wireless network according to an exemplary embodiment of the present invention. In the exemplary embodiment, a wireless network device that does not serve as a coordinator is called a “device.”

In a coordinator based wireless network, a coordinator 100 periodically broadcasts a beacon frame. This beacon frame includes information on the coordinator based wireless network. For example, the beacon frame may include channel time allocation information to be used by devices 201, 202, and 203, or information on devices that associate in or disassociate from the coordinator based wireless network. The beacon frame may also include channel time allocation information to be used by the coordinator itself or information on the coordinator itself.

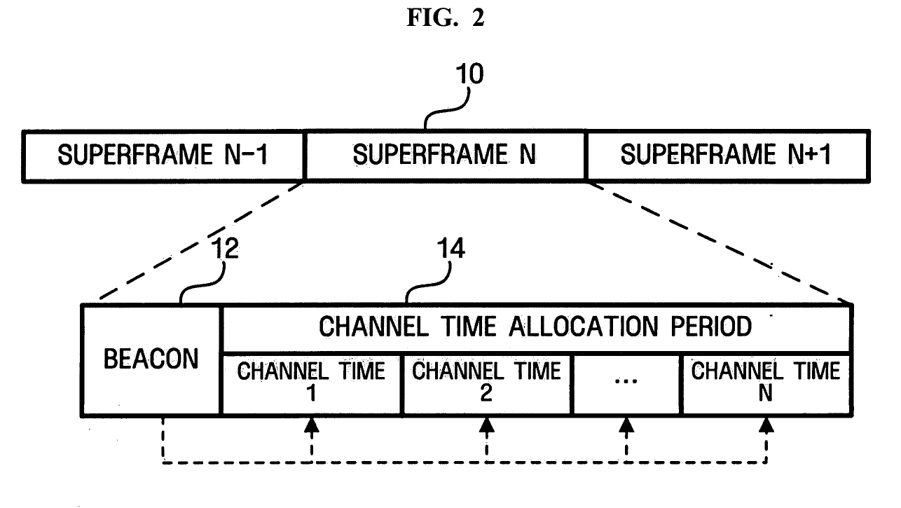

Through the beacon frame, a temporal arrangement structure as illustrated in FIG. 2 is managed. One superframe 10 is composed of a beacon frame 12 transmitted by the coordinator, and a channel time allocation period 14 in which the devices 201, 202, and 203 perform communications. The channel time allocation period 14 is subdivided into a plurality of channel times by the beacon frame 12. The devices 201, 202, and 203 having received the beacon frame 12 confirm the channel times allocated to themselves, and occupy a wireless medium at their corresponding channel times, respectively, to transmit data.

Referring again to FIG. 1, the coordinator 100 allocates logical addresses to the devices 201, 202, and 203. For example, if the coordinator based wireless network is a wireless personal area network (PAN) of the IEEE 802.15.3 standard, the coordinator 100 allocates device IDs to the devices 201, 202, and 203 as their logical addresses. The logical addresses allocated to the respective devices 201, 202, and 203 have a unique value in one coordinator based wireless network, and are used to identify the respective devices 201, 202, and 203.

If an IP communication is used in a coordinator based wireless network environment, the respective devices 201, 202, and 203 should be allocated with the IP addresses. In the exemplary embodiment of the present invention, network IDs are used to allocate IP addresses, and each device 201, 202, or 203 uses an association value of a network ID of a coordinator based wireless network to which the device belongs and its logical address, as its IP address.

A network ID is a value set by a coordinator 100 in a coordinator based wireless network, and is in the form of a specified IP address. For example, the coordinator may set the network ID to 192.168.1.0. In this case, a device which associates in the coordinator based wireless network of which the network ID is 192.168.1.0 and which has a logical address of 10, can use 192.168.1.10 that is the association value of the network ID and the logical address, as its IP address.

It is preferable that different network IDs are given to respective coordinator based wireless networks. The coordinator 100 can prevent the overlapping of a network ID through tuning with other neighboring coordinator based wireless networks when it initially forms its coordinator based wireless network. For example, the coordinator 100 can generate a network ID that does not overlap other network IDs used in other neighboring coordinator based wireless networks by receiving beacon frames of coordinators of other coordinator based wireless networks and confirming network IDs included in the received beacon frames. Hereinafter, a reference numeral “200” will denote a representative of the devices 201, 202, and 203.

In the exemplary embodiment of the present invention, the allocation of an IP address to a device 200 in a coordinator based wireless network environment can be performed by two methods.

One is a method in which the coordinator 100 allocates an IP address to the device 200. This IP address allocation method is called a passive allocation method. In the case of using the passive allocation method, the coordinator 100 generates an IP address using an association value of the network ID and a logical address of the device 200 when the device 200 requests the IP address to the coordinator 100.

As another example of the passive allocation method, the coordinator 100 generates an IP allocation order by counting the number of current IP address allocations If an IP address allocation request is received from the device 200, the coordinator 100 generates the IP address using the association value of the network ID and the next logical address in the IP allocation order. For example, if the device 200 requests the allocation of an IP address when the coordinator has allocated IP addresses to four devices, the IP address allocation order that may be used to generate an IP address to be allocated to the device 200 becomes 5. In this case, if the network ID is 192.168.1.0, the coordinator generates 192.168.1.5 as the IP address.

The coordinator 100 transmits the generated IP address to the device 200, and the device 200 set the IP address received from the coordinator 100.

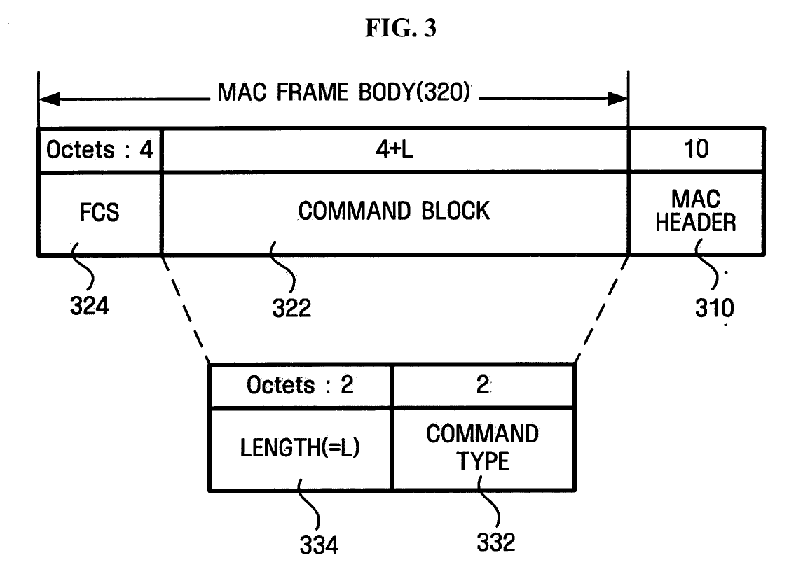

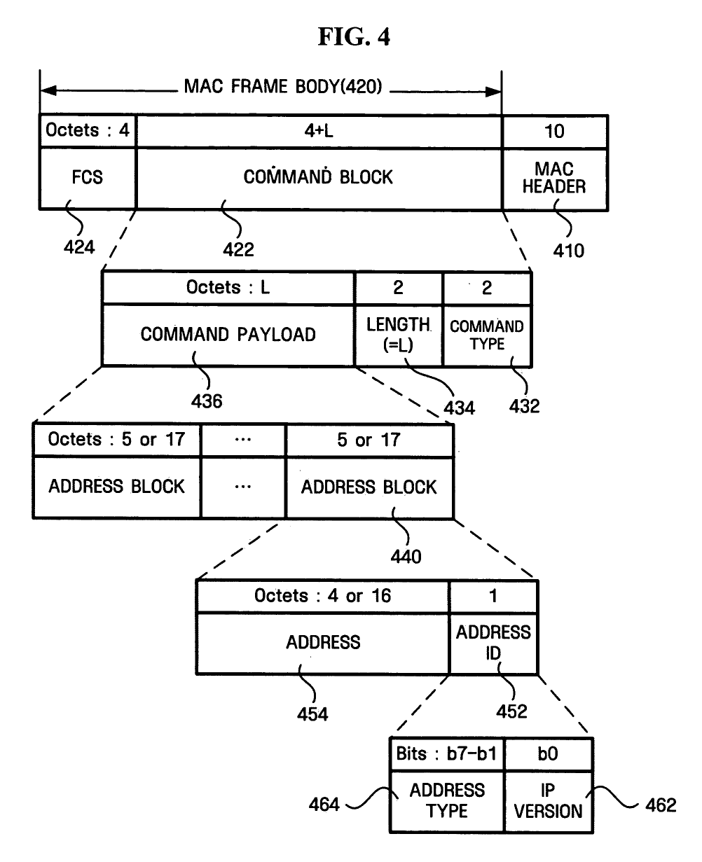

If the coordinator 100 and the device 200 support a MAC layer that follows the IEEE 802.15.3 standard, a command frame of the IEEE 802.15.3 standard can be used when the device 200 requests the IP address to the coordinator 100 or when the coordinator 100 transmits the IP address to the device 200. This operation will be explained in more detail with reference to FIGS. 3 and 4.

FIG. 3 is a diagram illustrating the structure of an IP request frame according to an exemplary embodiment of the present invention. An IP request frame as illustrated in FIG. 3 may be used when the device 200 requests the IP address to the coordinator 100. In the exemplary embodiments of the present invention, sizes of fields that constitute the IP request frame are illustrated. However, this is exemplary, and thus the present invention is not limited thereto.

The IP request frame includes a MAC header 310 and a MAC frame body 320. The MAC header 310 has a structure to a MAC header of the IEEE 802.15.3 standard. For example, in the MAC header 310, a logical address of the device 200 that sends the IP request frame and a logical address of the coordinator 100 that receives the IP request frame are set.

The MAC frame body 320 includes a frame check sum (FCS) field 324 that is used to distinguish between a command block 322 and a transmission error of the MAC frame.

The command block 322 is subdivided into a command type field 332 and a length field 334. The command type field 332 is to set a command type value for identifying the type of the command frame. For example, in the IEEE 802.15.3 standard, a command type value “0x0000” is allocated to a subscription request command, and a command type value “0x0001” is allocated to a subscription response command. In the exemplary embodiment of the present invention, one of reserved values “0x001D” to “0x00FF” among command type values prescribed in the IEEE 802.15.3 standard is allocated to the IP request frame. For example, a command type value “0x001D” may be used for the IP request frame, and in this case, the value “0x001D” may be set in the command type field 332. The length field 334 indicates the size of the command block except for the command type field 332 and the length field 334. In the exemplary embodiment of the present invention, the length field 334 may be set to “0”.

If the device 200 requests the allocation of the IP address to the coordinator through the command frame as described above, the coordinator 100 can allocate the IP address to the device 200 through the command frame as illustrated in FIG. 4.

FIG. 4 is a diagram illustrating the structure of an IP response frame according to an exemplary embodiment of the present invention.

An IP response frame as illustrated in FIG. 4 includes a MAC header 410 and a MAC frame body 420. The MAC header 410 has a structure similar to a MAC header of the IEEE 802.15.3 standard. For example, in the MAC header 410, a logical address of the coordinator 100 that sends the IP response frame and a logical address of the device 200 that receives the IP response frame are set.

The MAC frame body 420 includes an FCS field 424 that is used to distinguish between a command block 422 and a transmission error of the MAC frame.

The command block 422 is subdivided into a command type field 432, a length field 434, and a command payload 436. The command type field 432 is to set a command type value for identifying the type of the command frame. In the embodiment of the present invention, one of reserved values “0x001D” to “0x00FF” among command type values prescribed in the IEEE 802.15.3 standard is allocated to the IP response frame. For example, a command type value “0x001E” may be used for the IP response frame, and in this case, the value “0x001E” is set in the command type field 432. The length field 434 indicates the size of the command payload 436.

The command payload 436 may include one or more address blocks 440, and each address block 440 includes an address ID field 452 and an address field 454. In the address field 454, an IP address to be allocated to the device 200 is set. The IP address is generated using an association value of the network ID and the logical address of the device 200. However, the IP address may be generated using an association value of the network ID and the IP allocation order as described above. If needed, diverse IP information used for an IP communication, such as a DNS address, a gateway address, and a subnet mask, may be set in address fields of other address blocks.

In the exemplary embodiment of the present invention, the size of the address field 454 is set to 4 bytes or 16 bytes, and the size of the address field 454 is determined depending on the IP version to be used. For example, in the case of using IPv4, the size of the address field 454 may be set to 4 bytes, while in the case of using IPv6, it may be set to 16 bytes.

The address ID field 452 includes an IP version field 462 which indicates an IP version applied to the IP information that is set in the address field 454 (e.g., IPv4 or IPv6), and an address type field 464 which indicates the type of the IP information set in the address field 454.

Examples of the IP information that can be set in the address field 454 and the corresponding address type values that can be set in the address type field 464 are described in Table 1.

TABLE 1

| IP information | Address type value |
|---|---|
| IP address to be allocated to device | 0x01 |
| DNS address | 0x02 |
| Gateway address | 0x03 |
| Subnet mask | 0x04 |
| . . . | . . . |

The device 200 having received the IP response frame from the coordinator 100 can acquire the IP address allocated to it as well as other IP information used for the IP communication.

The other method of allocating an IP address in a coordinator based wireless network environment is a method in which the device 200 directly allocates its IP address. This IP address allocation method is called an active allocation method. In the case of using the active allocation method, the coordinator 100 informs the device 200 of the network ID by using a periodically broadcast beacon frame, and the device 200 generates its IP address using an association value of the network ID informed by the coordinator 100 and its logical address and sets the generated IP address.

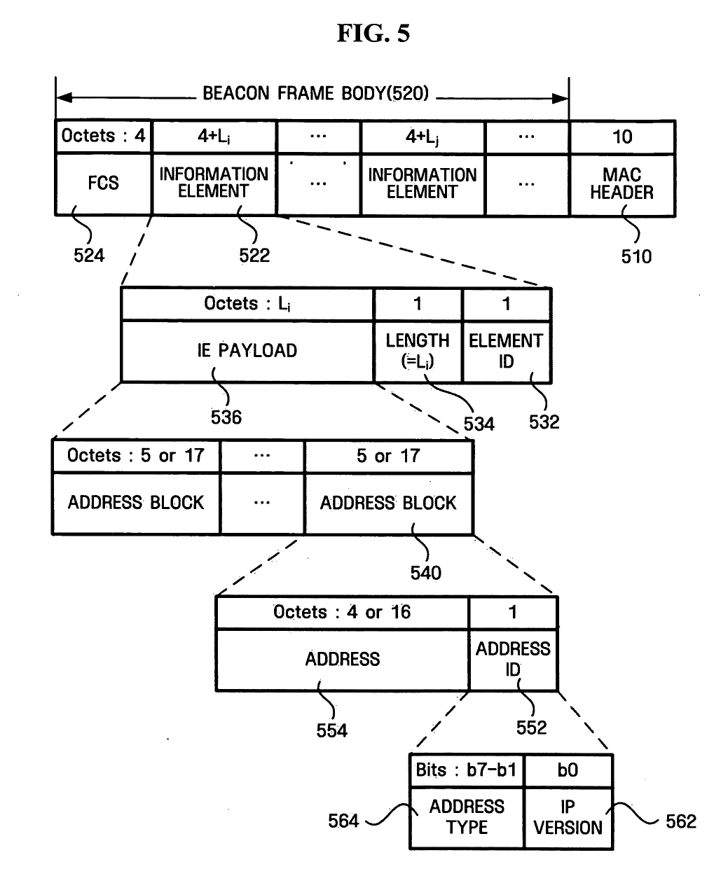

In the case in which the coordinator 100 and the device 200 support a MAC layer that follows the IEEE 802.15.3 standard, a beacon frame as illustrated in FIG. 5 may be used to inform the device of the network ID.

FIG. 5 is a diagram illustrating the structure of a beacon frame according to an embodiment of the present invention.

A beacon frame as illustrated in FIG. 5 includes a MAC header 510 and a beacon frame body 520. The MAC header 510 has a structure similar to a MAC header of the IEEE 802.15.3 standard. For example, in the MAC header 510, a logical address of the coordinator 100 that sends the beacon frame and a broadcast address for enabling all devices 200 to receive the beacon frameare set.

The beacon frame body 520 includes an FCS field 524 that is used to check a transmission error of the beacon frame, and one or more information element (IE) fields 522.

The respective IE field includes diverse information on the coordinator based wireless network. For example, a channel time allocation IE that is used in the IEEE 802.15.3 standard includes information on a channel time to be allocated to the device 200, and a device association IE includes information on devices that newly associate in or disassociate from the coordinator based wireless network. In the exemplary embodiment of the present invention, a network ID IE is defined in addition to IEs defined in the IEEE 802.15.3 standard.

The network ID IE includes an element ID field 532, a length field 534, and an IE payload 536. In the element ID field 532, an element ID value for identifying the type of the IE is set. For example, in the IEEE 802.15.3 standard, an element ID value “0x00” is allocated to the channel time allocation IE, and an element ID value “0x03” is allocated to the device association IE. In the exemplary embodiment of the present invention, one of reserved values “0x10” to “0x7F” among element ID values prescribed in the IEEE 802.15.3 standard is allocated to the network ID IE. For example, an element ID value “0x10” may be used for the network ID IE, and in this case, the value “0x10” is set in the element ID field 532. The length field 534 indicates the size of the IE payload 536.

The IE payload 536 may include one or more address blocks 540, and each address block 540 includes an address ID field 552 and an address field 554. In the address field 554, a network ID that is used in the coordinator based wireless network is set. The network ID is a value generated when the coordinator 100 initially forms the coordinator based wireless network, and is in the form of an IP address. If needed, diverse IP information used for the IP communication, such as a DNS address, a gateway address, and a subnet mask, may be set in address fields of other address blocks.

In the exemplary embodiment of the present invention, the size of the address field 554 is set to 4 bytes or 16 bytes, and the size of the address field 554 is determined depending on the IP version to be used. For example, in the case of using IPv4, the size of the address field 554 may be set to 4 bytes, while in the case of using IPv6, it may be set to 16 bytes.

The address ID field 552 includes an IP version field 562 which indicates an IP version applied to the IP information that is set in the address field 554 (e.g., IPv4 or IPv6), and an address type field 564 which indicates the type of the IP information set in the address field 554.

Examples of the IP information that can be set in the address field 554 and the corresponding address type values that can be set in the address type field 564 are described in Table 2.

TABLE 2

| IP information | Address type value |
|---|---|
| Network ID | 0x01 |
| DNS address | 0x02 |
| Gateway address | 0x03 |
| Subnet mask | 0x04 |
| . . . | . . . |

The device 200 having received the beacon frame from the coordinator 100 extracts the network ID from the beacon frame, and generates the IP address using the association value of the network ID and its logical address. Then, the device 200 sets the generated IP address, and thus it can perform the IP communication.

Hereinafter, the coordinator 100 and the device 200 will be explained in more detail.

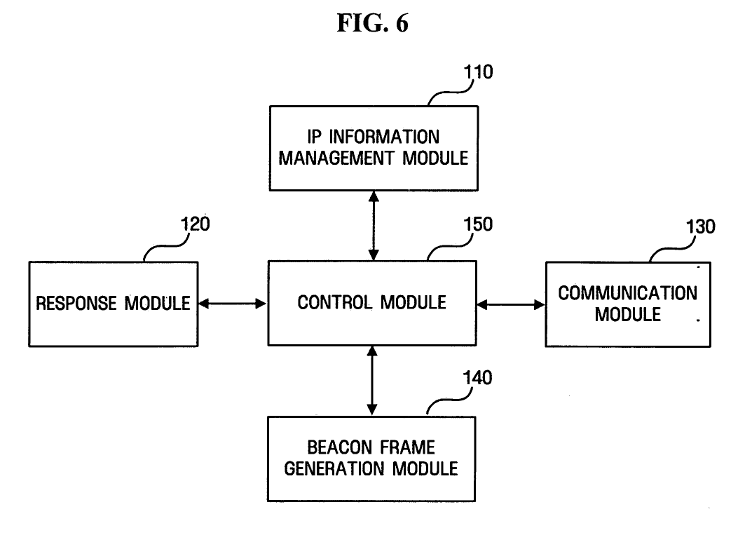

FIG. 6 is a block diagram illustrating the construction of a wireless network device according to an exemplary embodiment of the present invention. The wireless network device as illustrated in FIG. 6 serves as a coordinator 100.

The wireless network device includes an IP information management module 110, a response module 120, a communication module 130, a beacon frame generation module 140, and a control module 150.

The IP information management module 110 generates a network ID to be used in a coordinator based wireless network. If a passive allocation method is applied for the allocation of the IP address, the IP information management module 110 can generate the IP address using an association value of the network ID and the logical address of the device 200 that has requested the allocation of the IP address, or using an association value of the network ID and the IP address allocation order. In addition, the IP information management module 110 can manage diverse information used for the IP communication. For example, it can manage information such as a DNS address, a gateway address, a subnet mask, and others.

The response module 120 generates a response frame in response to requests transmitted from the device 200. For example, the response module 120 may generate a response frame in response to a channel time allocation request from the device or a subscription request of the device that intends to associate in the coordinator based wireless network.

If the passive allocation method is applied for the allocation of the IP address, the response module 120 can generate a response frame with respect to the IP address allocation request of the device 200 (hereinafter referred to as an “IP response frame”). The IP response frame includes the IP address generated by the IP information management module 110. The IP response frame may further include diverse IP information such as a DNS address, a gateway address, and a subnet mask. If the wireless network device supports a MAC layer of the IEEE 802.15.3 standard, the response module 120 can generate the IP response frame as explained with reference to FIG. 4.

The beacon frame generation module 130 generates a beacon frame. This beacon frame includes diverse information on the coordinator based wireless network. For example, the beacon frame may include channel time allocation information and information on devices that associate in or disassociate from the coordinator based wireless network.

If the active allocation method is applied for the allocation of the IP address, the beacon frame generation module 130 can generate a beacon frame that includes a network ID from the IP information management module 110. In addition, the beacon frame generation module 130 may further include diverse IP information such as a DNS address, a gateway address, and a subnet mask. If the wireless network device supports a MAC layer of the IEEE 802.15.3 standard, the beacon frame generation module 130 can generate the beacon frame that includes the IP information as explained with reference to FIG. 5.

The communication module 140 performs communications with other wireless network devices. For example, the communication module 140 may receive a specified request frame from the device 200, and transmit a response frame generated by the response module 120 or a beacon frame generated by the beacon frame generation module 130.

The control module 150 controls the operation of respective function blocks 110-140 that constitute the wireless network device illustrated in FIG. 6.

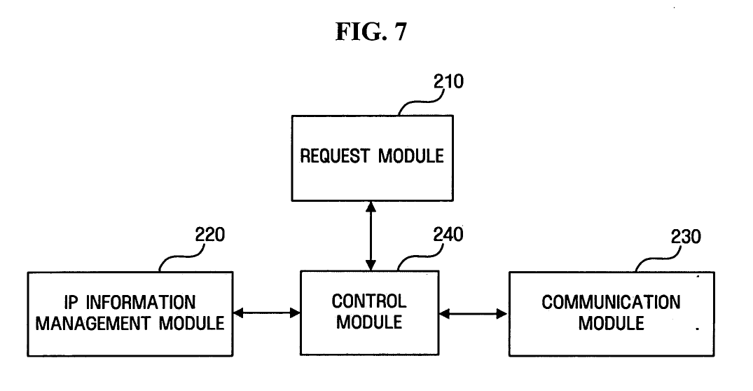

FIG. 7 is a block diagram illustrating the construction of a wireless network device according to another exemplary embodiment of the present invention. The wireless network device as illustrated in FIG. 7 serves as a device 200.

In this exemplary embodiment of the present invention, the wireless network device includes a request module 210, an IP information management module 220, a communication module 230, and a control module 240.

The request module 210 generates various kinds of request frames used for the communications in the wireless network. For example, the request module 210 may generate a request frame to request the channel time allocation or the association in the coordinator based wireless network. If the passive allocation method is applied for the allocation of the IP address, the request module 210 can generate a request frame for requesting the allocation of the IP address (hereinafter referred to as an “IP request frame”). If the wireless network device supports a MAC layer of the IEEE 802.15.3 standard, the request module 210 can generate the IP request frame as illustrated in FIG. 3.

The IP information management module 220 manages diverse IP information used for the IP communication. If the passive allocation method is used for the allocation of the IP address, the IP information management module 220 extracts the IP address from the IP response frame received from the coordinator 100. If the IP response frame further includes diverse IP information such as a DNS address, a gateway address, and a subnet mask, the IP information management module 220 extracts such information from the IP response frame and manages the extracted information.

If the active allocation method is used for the allocation of the IP address, the IP information management module 220 extracts the network ID from the beacon frame received from the coordinator 100. At this time, the IP information management module 220 generates the IP address using an association value of the network ID and the logical address allocated by the coordinator 100. If the beacon frame further includes diverse IP information such as a DNS address, a gateway address, and a subnet mask, the IP information management module 220 extracts such information from the IP response frame and manages the extracted information.

The communication module 230 performs communications with other wireless network devices. For example, the communication module 230 transmits the request frame generated by the request module 210 to the coordinator 100, and receives the response frame of the beacon frame from the coordinator 100.

The control module 240 controls the operation of function blocks 210-230 that constitute the wireless network device illustrated in FIG. 7.

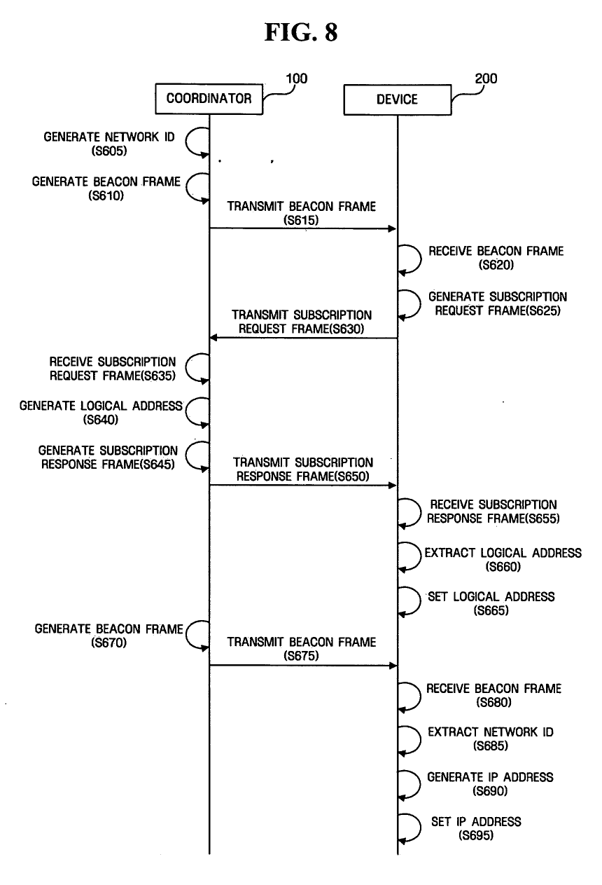

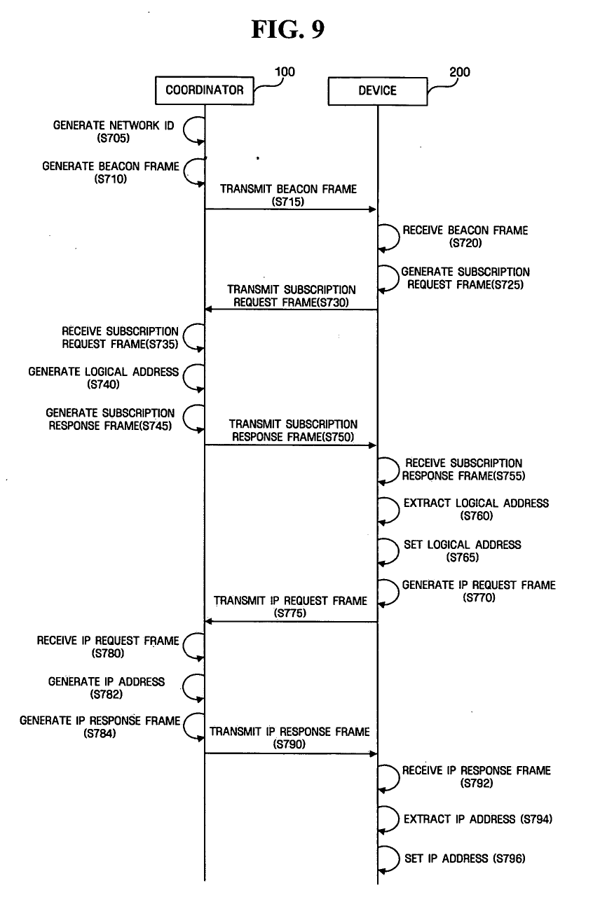

Hereinafter, the operation of the coordinator 100 and the device 200 will be explained in more detail with reference to FIGS. 8 and 9.

FIG. 8 is a flowchart illustrating an IP address allocation method according to an exemplary embodiment of the present invention. The IP address allocation process of FIG. 8 is in accordance with the active allocation method.

The IP information management module 110 of the coordinator 100 generates the network ID to be used in the coordinator based wireless network S605. The IP information management module 110 can generate the network ID which does not overlap network IDs that are used in other coordinator based wireless networks by confirming beacon frames of other coordinators that the communication module 140 has received.

Thereafter, the beacon frame generation module 130 generates the beacon frame that includes the network ID generated by the IP information management module 110 S610. In the exemplary embodiment of the present invention, the beacon frame generation module 130 may generate the beacon frame that further includes diverse IP information such as a DNS address, a gateway address, and a subnet mask. The beacon frame may further include other information on the coordinator based wireless network such as channel time allocation information. An example of the beacon frame that is generated by the beacon frame generation module 130 has been explained with reference to FIG. 5.

When the beacon frame is generated, the communication module 140 transmits the generated beacon frame to the wireless medium S615. The generation and transmission of the beacon frame may be performed periodically.

If the communication module 230 of the device 200 that intends to associate in the coordinator based wireless network receives the beacon frame S620, the device 200 can recognize the existence of the coordinator 100 and information on the coordinator based wireless network. In this case, the request module 210 generates a subscription request frame for associating in the coordinator based wireless network S625, and the communication module 230 transmits the subscription request frame S630 to the coordinator 100.

When the communication module 140 of the coordinator 100 receives the subscription request frame from the device 200 S635, the control module 150 generates a logical address to be allocated to the device 200 S640, and the response module 120 generates a subscription response frame that includes the logical address S645.

Thereafter, if the communication module 140 of the coordinator 100 transmits the subscription response frame S650, the communication module 230 of the device 200 receives the transmitted subscription response frame S655. Then, the control module 240 of the device 200 extracts the logical address from the subscription response frame S660, and sets the extracted logical address S665. Accordingly, the device 200 uses the logical address set by the control module 240 in the coordinator based wireless network.

Through the above-described process, the device 200 can associate in the coordinator based wireless network. The association of the device 200 in the coordinator based wireless network could be concretely understood through the IEEE 802.15.3 standard.

If the device 200 associates in the coordinator based wireless network, the beacon frame generation module 130 of the coordinator 100 generates the beacon frame that includes information on the device 200 that newly associates when the next beacon frame is generated S670. In this case, the generated beacon frame includes the network ID and other IP information in the same manner as step S610.

When the beacon frame is generated, the communication module 140 transmits the generated beacon frame to the wireless medium S675.

If the communication module 230 of the device 200 receives the beacon frame from the coordinator 100 S680, the IP information management module 220 extracts the network ID from the beacon frame S685, and generates the IP address using an association value of the extracted network ID and the logical address allocated from the coordinator 100 S690.

Then, the control module 240 sets the generated IP address S695.

The IP information management module 220 may extract diverse IP information such as the DNS address, gateway address, and subnet mask from the beacon frame, and manage the extracted information. By doing this, the device 200 can perform the IP communication using the IP address set by the control module in the coordinator based wireless network.

FIG. 9 is a flowchart illustrating an IP address allocation method according to another exemplary embodiment of the present invention. The IP address allocation process of FIG. 9 is in accordance with the passive allocation method.

The IP information management module 110 of the coordinator 100 generates the network ID to be used in the coordinator based wireless network S705. The IP information management module 110 can generate a network ID which does not overlap network IDs that are used in other coordinator based wireless networks by confirming beacon frames of other coordinators that the communication module 140 has received.

Thereafter, the beacon frame generation module 130 generates the beacon frame S710. The beacon frame includes information on the coordinator based wireless network formed by the coordinator 100. For example, the beacon frame may include channel time allocation information, and information on devices that associate in or disassociate from the coordinator based wireless network.

If the beacon frame is generated, the communication module 140 transmits the generated beacon frame to the wireless medium S715. The generation and transmission of the beacon frame may be performed periodically.

Since the steps S720 to S765 in the exemplary embodiment as illustrated in FIG. 9, which refer to the association of the device 200 in the coordinator based wireless network, can be understood in the same manner as the steps S620 to S665 in the exemplary embodiment as illustrated in FIG. 8, the detailed explanation thereof will be omitted.

When the device 200 associates in the coordinator based wireless network, the request module 210 of the device 200 generates the IP request frame S770, and the communication module 230 transmits the generated IP request frame to the coordinator 100 S775. An example of the IP request frame has been explained with reference to FIG. 3.

If the communication module 140 of the coordinator 100 receives the IP request frame from the device S780, the IP information management module 110 generates the IP address using an association value of the network ID generated in the step S705 and the logical address of the device 200 having transmitted the IP request frame S782. If the IP address is generated, the response module 120 generates the IP response frame that includes the IP address S784. The IP response frame may further include diverse IP information managed by the IP information management module 110, such as the DNS address, gateway address, and subnet mask. An example of the IP response frame has been explained with reference to FIG. 4.

If the communication module 140 of the coordinator 100 transmits the IP response frame S790 and the communication module 230 of the device receives the transmitted IP response frame S792, the IP information management module 220 of the device 200 extracts the IP address from the IP response frame S794. Then, the control module 240 sets the extracted IP address S796.

In addition, the IP information management module 220 may extract diverse IP information such as the DNS address, gateway address, and subnet mask from the beacon frame, and manage the extracted information. By doing this, the device 200 can perform the IP communication using the IP address set by the control module in the coordinator based wireless network.

As another example of the passive allocation method, the coordinator 100 may generate the IP address using an association value of the network ID and the IP address allocation order, and allocate the generated IP address to the device 200. For example, if the coordinator 100 has currently allocated three IP addresses, the IP address allocation order during the next IP allocation will be “4”. In this case, if the device 200 requests the allocation of the IP address in a state that the network ID is 192.168.1.0, the coordinator 100 can allocate 192.168.1.4, which has been generated using the association value of the network ID and the IP address allocation order, to the device 200 as the IP address. In this exemplary embodiment, the step S782 of FIG. 9 can be replaced by a process in which the IP information management module 110 generates the IP address using the association value of the network ID generated in the step S705 and the IP address allocation order.

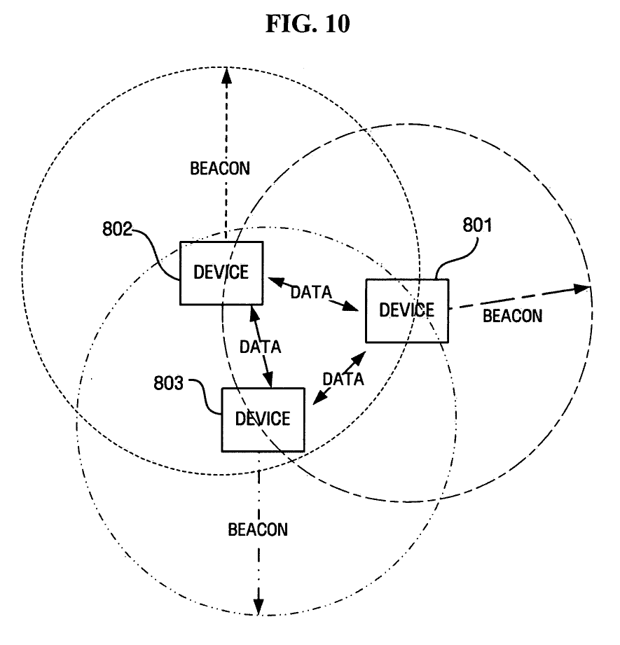

The IP address allocation method in the coordinator based wireless network has been explained. Hereinafter, an IP address allocation method in a distributed wireless network will be explained with reference to FIGS. 10 to 14.

FIG. 10 is a diagram illustrating a distributed wireless network according to an exemplary embodiment of the present invention.

In the distributed wireless network, all wireless network devices 801, 802, and 803 broadcast beacon frames. The beacon frame includes information on the channel time to be used. In FIG. 10, circles drawn around respective wireless network devices 801, 802, and 803 indicate arrival ranges of beacon frames broadcast by the respective wireless network devices 801, 802, and 803. Hereinafter, a reference numeral “800” will denote a representative of the wireless network devices 801, 802, and 803.

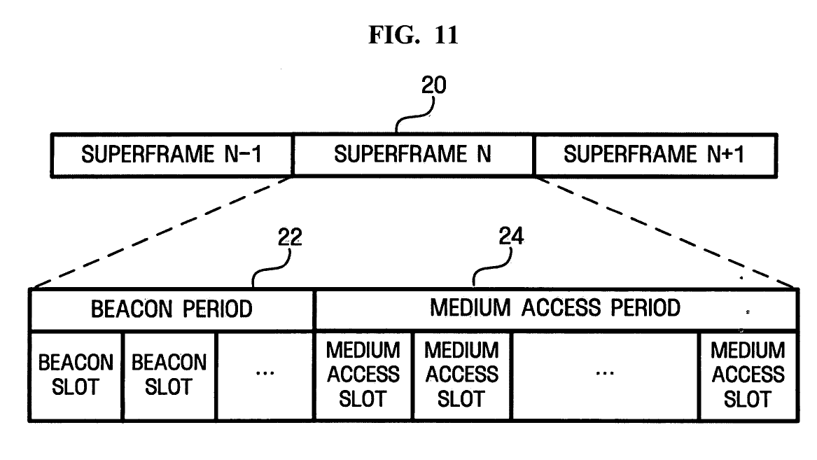

A temporal arrangement structure for communications of a wireless network device 800 in a distributed wireless network is illustrated in FIG. 11. In the temporal arrangement structure of the distributed wireless network, one superframe 20 may be composed of a beacon period 22 in which the wireless network device 800 can transmit a beacon frame and a medium access period 24 in which the wireless network device can transmit frames except for the beacon frame.

The beacon period 22 is composed of a plurality of beacon slots, and the wireless network device 800 transmits its own beacon frame by using one of the beacon slots. Accordingly, the wireless network device 800 that intends to associate in the distributed wireless network scans beacon frames that are transmitted from other wireless network devices during at least one superframe period. If no beacon frame is detected as a result of scanning the beacon frames, the wireless network device 800 transmits its own beacon frame at a certain point of time, so that the distributed wireless network can be formed. If a beacon frame is detected as a result of scanning, the wireless network device 800 can confirm beacon slots that have not yet been occupied through the detected beacon frame, and can transmit a beacon frame by using the non-occupied beacon slot in a beacon period of the next superframe. The wireless network device 800 selects a medium access slot to be occupied through the beacon frame, and transmit desired data in the corresponding medium access slot. Here, the medium access slot is similar in concept to the above-described channel time.

In addition, the wireless network device 800 determines the logical address that the device itself will use in the distributed wireless network. The wireless network device 800 can confirm logical addresses being used by other wireless network devices through the beacon frame detected as a result of scanning the beacon frames. Accordingly, the wireless network device 800 can make its logical address not overlap logical values of other wireless network devices. As an example for determining the logical address, the wireless network device 800 may select a certain logical address among a plurality of logical addresses having the same probability value.

If the IP communication is required in a distributed wireless network environment, the wireless network device 800 requires an IP address. In the exemplary embodiments of the present invention, a network ID is used for the allocation of the IP address, and the wireless network device uses an association value of the network ID of the distributed wireless network, in which the wireless network device itself associates, and its own logical address, as its IP address.

The network ID has a value set by the wireless network device that initially formed the distributed wireless network. For example, if the wireless network device 800 detects no beacon frame as a result of scanning the beacon frames, it can set a certain network ID and broadcast a beacon frame that includes the set network ID. If the wireless network device 800 detects any beacon frame, it can acquire the network ID included in the detected beacon frame.

The network ID may be in the form of an IP address. For example, the network ID may be 192.168.1.0. Accordingly, the wireless network device, which associates in the distributed wireless network having the network ID of 192.168.1.0 and of which the logical address is “10”, uses 192.168.1.10 that is the association value of the network ID and the logical address, as its IP address.

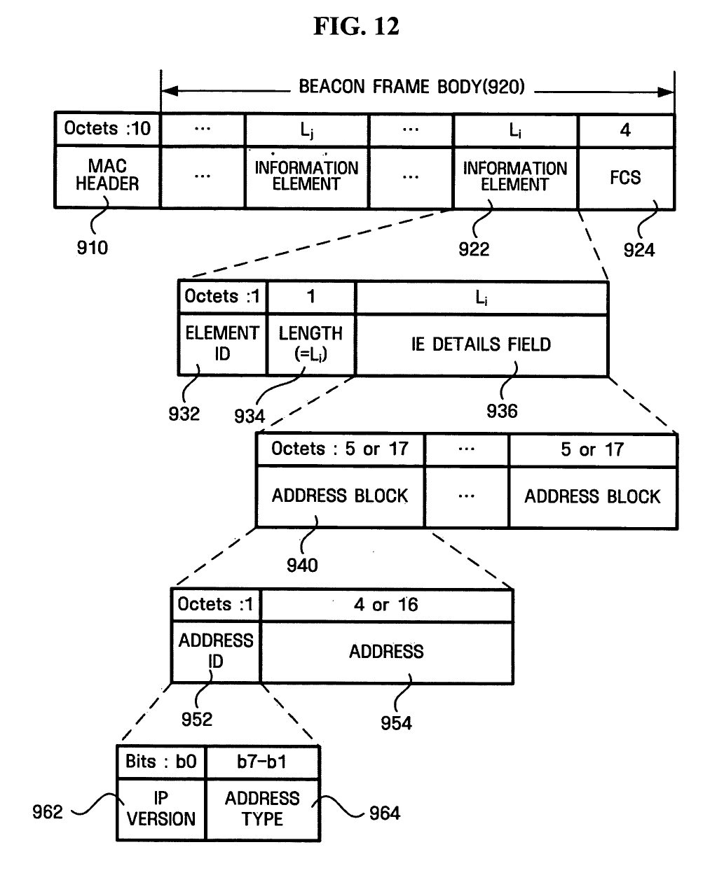

FIG. 12 is a diagram illustrating the structure of a beacon frame according to an exemplary embodiment of the present invention.

A beacon frame as illustrated in FIG. 12 includes a MAC header 910 and a beacon frame body 920. If the illustrated beacon frame follows the MBOA MAC standard, the MAC header 910 has a structure similar to a MAC header of the MBOA MAC standard. For example, in the MAC header 910, a logical address of the wireless network device 800 that transmits the beacon frame, and a broadcast address for enabling all wireless network devices to receive the beacon frame may be set.

The beacon frame body 920 includes an FCS field 924 that is used to check a transmission error of the beacon frame, and one or more IE fields 922.

The respective IE field includes diverse information on the distributed wireless network. The IE field may include reservation information on the medium access slot that the wireless network device 800 having transmitted the beacon frame intends to occupy. In the exemplary embodiment of the present invention, a network ID IE is defined.

The network ID IE includes an element ID field 932, a length field 934, and an IE details field 936. In the element ID field 932, an element ID value for identifying the type of the IE is set. If the illustrated beacon frame follows the MBOA MAC standard, one of reserved values “21” to “254” among element ID values that are used to identify the IEs in the MBOA MAC standard can be allocated to the network ID IE. For example, the element ID value “21” can be used for the network ID IE, and in this case, the value “21” is set in the element ID field 932. The length field 934 indicates the size of the IE details field 936.

The IE details field 936 may include one or more address blocks 940, and each address block 940 includes an address ID field 952 and an address field 954. In the address field 954, the network ID of the distributed wireless network is set. As described above, the network ID is a value generated by the wireless network device that initially formed the distributed wireless network, and is in the form of a specified IP address. If needed, diverse IP information required for the IP communication, such as a DNS address, a gateway address, and a subnet mask, may be set in address fields of other address blocks.

In the exemplary embodiment of the present invention, the size of the address field 954 is set to 4 bytes or 16 bytes, and the size of the address field 954 is determined depending on the IP version to be used. For example, in the case of using IPv4, the size of the address field 954 may be set to 4 bytes, while in the case of using IPv6, it may be set to 16 bytes.

The address ID field 952 includes an IP version field 562 which indicates an IP version applied to the IP information that is set in the address field 954 (e.g., IPv4 or IPv6), and an address type field 964 which indicates the type of the IP information set in the address field 954.

As described above, examples of the IP information that can be set in the address field 954 and the corresponding address type values that can be set in the address type field 964 are described in Table 2.

If the wireless network device 800 detects such a beacon frame as a result of scanning beacon frames before it associates in the distributed wireless network, it extracts the network ID from the detected beacon frame, and generates the IP address using the association value of the network ID and its own logical address. Thereafter, the wireless network device 800 sets the generated IP address, so that the IP communication can be performed.

Hereinafter, the wireless network device 800 will be explained in detail.

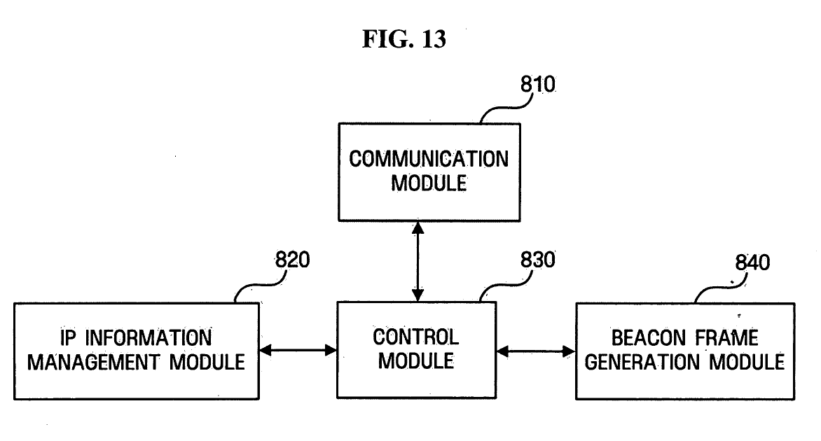

FIG. 13 is a block diagram illustrating the construction of a wireless network device according to an exemplary embodiment of the present invention.

The wireless network device 800 as illustrated in FIG. 13 includes a communication module 810, an IP information management module 820, a control module 830, and a beacon frame generation module 840.

The communication module 810 performs the communication with other wireless network devices. Also, the communication module 810 scans beacon frames transmitted from other wireless network devices.

The IP information management module 820 generates the network ID if the communication module 810 detects no beacon frame as a result of scanning the beacon frames. If the communication module 810 detects a beacon frame as a result of scanning, the IP information management module 820 extracts the network ID from the detected beacon frame.

Also, the IP information management module 820 generates the IP address using the association value of the network ID and the logical address set by the control module 830. In addition, the IP information management module 820 can manage diverse IP information such as the DNS address, gateway address, and subnet mask.

The control module 830 sets the logical address to be used by the wireless network device 800. For example, the control module 830 selects a certain logical address among a plurality of logical addresses having the same probability value, and sets the selected logical address. At this time, the control module 830 can confirm the logical addresses being used by other wireless network devices through the beacon frame detected as a result of scanning the beacon frames. Accordingly, the control module 830 can set the logical address that does not overlap logical addresses of other wireless network devices. The logical address is used to identify the wireless network device in the distributed wireless network.

The beacon frame generation module 840 generates the beacon frame that includes the network ID. In addition, the beacon frame may include IP information such as the DNS address, gateway address, and subnet mask, and reservation information of the medium access slots.

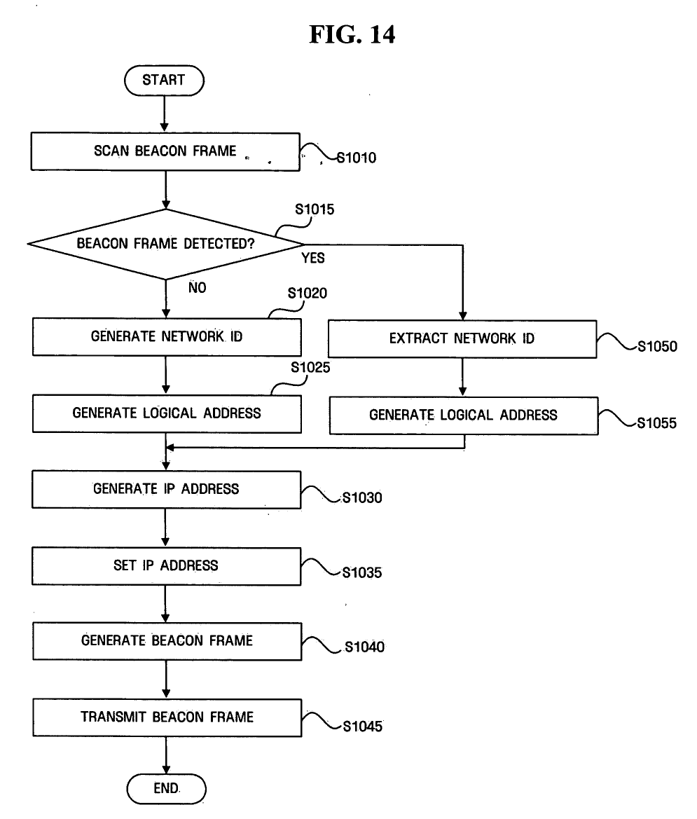

Hereinafter, the operation of the wireless network device will be explained in more detail with reference to FIG. 14.

FIG. 14 is a flowchart illustrating an IP address allocation method according to still another exemplary embodiment of the present invention.

The communication module 810 of the wireless network device 800 that intends to associate in the distributed wireless network scans beacon frames of other wireless network devices S1010.

If no beacon frame is detected as a result of scanning the beacon frames S1015, the IP information management module 820 generates the network ID, and the control module 830 generates the logical address S1025. As described above, the network ID is in the form of an IP address, and is used to identify the wireless network device in the distributed wireless network.

Then, the IP information management module 820 generates the IP address using the association value of the generated network ID and the logical address generated by the control module S1030, and the control module 830 sets the generated IP address S1035. Accordingly, the wireless network device 800 can perform the IP communication by using the IP address set by the control module 830 in the distributed wireless network.

In this case, the beacon frame generation module 840 generates the beacon frame that includes the network ID generated by the IP information management module 820 S1040, and the communication module 810 transmits the generated beacon frame to the wireless medium S1045. The beacon frame may further include diverse IP information managed by the IP information management module 820, such as the DNS address, gateway address, and subnet mask, and reservation information on the medium access slot to be used by the wireless network device 800. An example of the beacon frame has been explained with reference to FIG. 12.

If the communication module 810 detects a beacon frame as a result of scanning the beacon frames S1015, the IP information management module 820 extracts the network ID from the detected beacon frame S1050.

In this case, the control module 830 generates the logical address S1055, and makes the generated logical address not overlap the logical address that is used by the wireless network device having transmitted the beacon frame detected by the communication module 810.

If the logical address is generated by the control module 830, the IP information management module 820 generates the IP address using the association value of the network ID extracted from the beacon frame and the logical address generated by the control module 830 S1030. In this case, the control module 830 sets the generated IP address S1035, so that the wireless network device 800 can use the corresponding IP address.

The beacon generation module 840 confirms the usable beacon slots and medium access slots through the detected beacon frames, and generates the beacon frame that includes reservation information on the medium access slot to be occupied by the wireless network device 800 S1040. As described above with reference to FIG. 12, the generated beacon frame includes the network ID.

Thereafter, the communication module 810 transmits the beacon frame through the usable beacon slot.

In the exemplary embodiments of the present invention, the term “unit”, as used herein to indicate a function block constituting a respective wireless network device, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

As described above, according to the method and apparatus for dynamically allocating an IP address in a wireless network according to the exemplary embodiments of the present invention, an IP address can be allocated with a small amount of computation in a ad-hoc mode wireless network.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method of dynamically allocating an Internet protocol (IP) address in a wireless network, the method comprising:
associating a wireless network device in a wireless network; and
setting an IP address using an association value of a network ID of the wireless network and a logical address used to identify the wireless network device in the wireless network.

2. The method of claim 1, wherein the wireless network is a coordinator based wireless network.

3. The method of claim 2, wherein the network ID is generated by a coordinator of the coordinator based wireless network, and the logical address is allocated from the coordinator.

4. The method of claim 2, wherein the coordinator based wireless network is a wireless network that follows the IEEE 802.15.3 standard.

5. The method of claim 2, wherein the setting the IP address comprises:
requesting the IP address to a coordinator of the coordinator based wireless network;
receiving from the coordinator as a result of the request a response frame comprising the IP address generated using the association value of the network ID and the logical address; and
setting the IP address received in the response frame.

6. The method of claim 5, wherein the response frame comprises at least one of a DNS address, a gateway address, and a subnet mask.

7. The method of claim 2, wherein the setting the IP address comprises:
receiving a beacon frame comprising the network ID from a coordinator of the coordinator based wireless network;
generating the IP address using the association value of the network ID received in the beacon frame and the logical address; and
setting the generated IP address.

8. The method of claim 7, wherein the beacon frame further comprises at least one of a DNS address, a gateway address, and a subnet mask.

9. The method of claim 1, wherein the wireless network is a distributed wireless network.

10. The method of claim 9, wherein the distributed wireless network is a wireless network that follows the multiband OFDM alliance medium access control (MBOA MAC) standard.

11. The method of claim 9, further comprising generating the logical address,
wherein the network ID has a value generated by a wireless network device that initially formed the distributed wireless network.

12. The method of claim 9, wherein the setting the IP address comprises:
receiving a beacon frame comprising the network ID from an other wireless network device comprising the distributed wireless network;
generating the IP address using the association value of the network ID included in the beacon frame and the logical address; and
setting the generated IP address.

13. The method of claim 12, wherein the beacon frame further comprises at least one of a DNS address, a gateway address, and a subnet mask.

14. The method of claim 9, further comprising:
generating a beacon frame that comprises the network ID; and
broadcasting the generated beacon frame.

15. A method of dynamically allocating an Internet protocol (IP) address in a wireless network, the method comprising:
requesting an IP address to a coordinator of a coordinator based wireless network;
receiving from the coordinator as a result of the request a response frame that includes the IP address generated using an association value of a network ID used in the coordinator based wireless network and an IP address allocation order generated in accordance with the coordinator's allocation of the IP address; and
setting the IP address received in the response frame.

16. A method of dynamically allocating an Internet protocol (IP) address in a wireless network, the method comprising:
receiving an IP address allocation request from a wireless network device in a coordinator based wireless network;
generating an IP address using an association value of a network ID used in the coordinator based wireless network and a logical address of the wireless network device; and
transmitting a response frame comprising the generated IP address to the wireless network device.

17. The method of claim 16, wherein the response frame further comprises at least one of a DNS address, a gateway address, and a subnet mask.

18. The method of claim 16, further comprising generating the network ID.

19. The method of claim 16, wherein the coordinator based wireless network follows the IEEE 802.15.3 standard.

20. A method of dynamically allocating an Internet protocol (IP) address in a wireless network, the method comprising:
receiving an IP address allocation request from a wireless network device in a coordinator based wireless network;
generating an IP address using an association value of a network ID used in the coordinator based wireless network and an IP address allocation order generated in accordance with the allocation of the IP address; and
transmitting a response frame comprising the generated IP address to the wireless network device.

21. A method of dynamically allocating an Internet protocol (IP) address in a wireless network, the method comprising:
generating a network ID to be used in a specified wireless network;
generating a beacon frame comprising the network ID; and
broadcasting the beacon frame,
wherein a wireless network device having received the beacon frame generates an IP address by connecting the network ID with a logical address of the wireless network device.

22. The method of claim 21, wherein the beacon frame further comprises at least one of a DNS address, a gateway address, and a subnet mask.

23. The method of claim 21, wherein the wireless network is a coordinator based wireless network.

24. The method of claim 23, wherein the coordinator based wireless network follows the IEEE 802.15.3 standard.

25. The method of claim 21, wherein the wireless network is a distributed wireless network.

26. The method of claim 25, wherein the distributed wireless network is a wireless network that follows the multiband OFDM alliance medium access control (MBOA MAC) standard.

27. A wireless network device comprising:
a communication module receiving a beacon frame comprising a network ID in a specified wireless network;
an Internet protocol (IP) information management module generating an IP address using an association value of the network ID received in the beacon frame and a logical address used to identify a wireless network device in the wireless network; and
a control module setting the generated IP address.

28. The wireless network device of claim 27, wherein the beacon frame further comprises at least one of a DNS address, a gateway address and a subnet mask, and
wherein the IP information management module manages the DNS address, the gateway address, and the subnet mask, comprising the beacon frame.

29. The wireless network device of claim 27, wherein the wireless network is a coordinator based wireless network.

30. The wireless network device of claim 29, wherein the network ID is generated by a coordinator of the coordinator based wireless network, and the logical address is allocated from the coordinator.

31. The wireless network device of claim 29, wherein the coordinator based wireless network is a wireless network that follows the IEEE 802.15.3 standard.

32. The wireless network device of claim 27, wherein the wireless network is a distributed wireless network.

33. The wireless network device of claim 32, wherein the distributed wireless network is a wireless network that follows the multiband OFDM alliance medium access control (MBOA MAC) standard.

34. The wireless network device of claim 32, wherein the control module generates the logical address, and the network ID has a value generated by a device that initially formed the distributed wireless network.

35. The wireless network device of claim 32, further comprising a beacon frame generation module generating the beacon frame comprising the network ID,
wherein the communication module broadcasts the generated beacon frame.

36. A wireless network device comprising:
a request module generating a request frame for requesting an Internet protocol (IP) address to a coordinator of a coordinator based wireless network;
a communication module transmitting the request frame to the coordinator, and receiving from the coordinator a response frame comprising the IP address generated using an association value of a network ID of the coordinator based wireless network and a logical address used to identify a wireless network device in the coordinator based wireless network; and
a control module setting the IP address comprising the response frame.

37. The wireless network device of claim 36, wherein the network ID is generated by the coordinator, and the logical address is allocated from the coordinator.

38. The wireless network device of claim 36, wherein the coordinator based wireless network is a wireless network that follows the IEEE 802.15.3 standard.

39. The wireless network device of claim 36, wherein the response frame further comprises at least one of a DNS address, a gateway address and a subnet mask, and
wherein the wireless network device further comprises an IP information management module that manages the DNS address, the gateway address, and the subnet mask.

40. A wireless network device comprising:
an Internet protocol (IP) information management module generating an IP address using an association value of a network ID used in a coordinator based wireless network and a logical address of a wireless network device having requested an allocation of the IP address;
a response module generating a response frame comprising the IP address; and
a communication module receiving the IP address allocation request from a wireless network device, and transmitting the response frame to the wireless network device.

41. The wireless network device of claim 40, wherein the response frame further comprises at least one of a DNS address, a gateway address, and a subnet mask.

42. The wireless network device of claim 40, wherein the IP information management module generates the network ID.

43. The wireless network device of claim 40, wherein the coordinator based wireless network is a wireless network that follows the IEEE 802.15.3 standard.

44. A wireless network device comprising:
an Internet protocol (IP) information management module generating a network ID used in a specified wireless network;
a beacon frame generation module generating a beacon frame comprising the network ID; and
a communication module broadcasting the beacon frame,
wherein a wireless network device having received the beacon frame generates an IP address by connecting the network ID with a logical address of the wireless network device.

45. The wireless network device of claim 44, wherein the beacon frame further comprises at least one of a DNS address, a gateway address, and a subnet mask.

46. The wireless network device of claim 44, wherein the wireless network is a coordinator based wireless network.

47. The wireless network device of claim 46, wherein the coordinator based wireless network is a wireless network that follows the IEEE 802.15.3 standard.

48. The wireless network device of claim 44, wherein the wireless network is a distributed wireless network.

49. The wireless network device of claim 48, wherein the distributed wireless network is a wireless network that follows the multiband OFDM alliance medium access control (MBOA MAC) standard.
